(19) United States
(12) Patent Application Publication
(10) Pub. No.: US 2021/0141830 A1
(43) Pub. Date: May 13, 2021

(54) ACCURATE AND VERIFIABLE DATA RECORD CAPTURE AND PRESENTATION

(71) Applicant: Western Patent, LLC, Draper, UT (US)

(72) Inventor: David G. Tanner, Draper, UT (US)

(21) Appl. No.: 16/679,716

(22) Filed: Nov. 11, 2019

(51) Int. Cl. G06F 16/904; G06F 16/907; G06F 16/901; G06F 16/9038; G06F 16/955

(52) U.S. Cl. CPC G06F 16/904; G06F 16/907; G06F 16/955; G06F 16/9038; G06F 16/9014

(57) ABSTRACT

Capturing an accurate and verifiable representation of a data record includes accessing displayable data of the data record and presentation information from a data source. The displayable data is rendered according to the presentation information. A visual representation of the rendered displayable data is captured. A representation of the data record is stored, including storing one or more metadata items identifying the data record, the captured visual representation of the rendered data record, cryptographic information usable to verify integrity of the stored data record, and a timestamp. Later, an accurate and verified representation of the data record can be provided using the cryptographic information to verify integrity of the representation of the data record, and then providing the one or more metadata items, the one or more captured visual representations, and the timestamp.

### BACKGROUND

As computing devices have penetrated nearly every aspect of modern life, they have become a vast repository of many different types of information. Much of this information is exposed and accessible on computer networks, such as local-area networks and wide-area networks (e.g., such as the Internet). In many instances, network-accessible information is logically organized into identifiable data records, which might group together different pieces of related information.

In some circumstances, data records might be exposed on a network in a highly structured manner. For example, data records might be exposed on a network (e.g., using the Structured Query Language (SQL)) as rows of data in a relational database table that uses a well-defined schema (e.g., in which each piece of information comprising a data record is stored in a column having a well-defined identity and/or data type). In another example, data records might be exposed on a network using some other highly structured format, such as the eXtensible Markup Language (XML), the JavaScript Object Notation (JSON), and the like.

In many other circumstances, however, data records are exposed on a network in an unstructured manner. For instance, it may be that a data record comprises unstructured text, one or more images (e.g., a digital representation of a physical document, a video, etc.), audio data, and the like, with no indication of the meaning of this data.

Whether an underlying data record is structured or unstructured, the data record might be exposed along with visual-formatting information (e.g., using the HyperText Markup Language (HTML), Cascading Style Sheets (CSS), etc.). This formatting information can direct how a visual layout and/or visual style should be applied to the data record. If the underlying data record is unstructured, this visual formatting information may impart little, or no, meaning to the structure and format of the underlying record data, itself, and that is readily identifiable by a computer system. If the underlying data record is structured, this visual formatting information may actually operate to confuse or obfuscate the underlying structure of the data. For example, while a web page might be generated in reliance on data stored in a structured database table, the manner in which this data is presented within a webpage might not clearly or accurately communicate the data's underlying structure.

It may be desirable to perform searches across various disparate collections of data records (whether they comprise structured and/or unstructured data records). For example, each of a plurality of different source computer systems might provide functionality for searching and exposing a different collection of data records that is stored at that source computer system. Thus, it may be possible to access each of these source computer systems over a network, and to individually search each source computer system's collection of data records to locate potentially related data records across the various collections.

### BRIEF SUMMARY

At least some embodiments described herein are directed to computer-implemented data aggregation techniques that create aggregate collection(s) of data records that are sourced from a plurality of different source computer systems, each of which exposes its own collection(s) of data records. Thus, the techniques described herein can create aggregate collection(s) of data records that include the actual data obtained from data records stored in the various collections exposed by these disparate source computer systems. Embodiments can then offer the ability to search these aggregate collection(s), and to return matching data record data directly from these aggregate collection(s). Thus, the embodiments herein enable a searcher to perform searches across these various collections of data records (i.e., by virtue of searching the aggregate collection(s)), and to obtain information from the data records themselves, without actually needing to interact directly with the source computer systems from which the data records originated.

Notably, the inventor has recognized that significant technical challenges arise when implementing such computer-implemented data aggregation techniques. In particular, the inventor has recognized that it can be technically challenging to create aggregate collection(s) that include, and can in turn provide, a complete and/or accurate representation of a source data record as it would have been provided by a source computer system, itself. For example, while different source computer systems might expose similar types of data records, these source computer systems might do so in different ways. For instance, different source computer systems might refer to similar types of information with different or inconsistent naming standards, or might use different or inconsistent data formatting techniques. Additionally, in the case of unstructured data, it may be difficult to accurately determine what data types and formats are being presented by a source computer system.

Thus, it can frequently be difficult, and sometimes impossible, for a data aggregation system to parse and store data from different source computer systems in a unified and consistent way, even if the data record types are similar across the source computer systems. This frequently leads to data aggregation systems storing incomplete representations of source data records (e.g., where a source data record includes data of a type that cannot be determined, or that doesn't map to a data type used by the data aggregation system). Additionally, or alternatively, this frequently leads to data aggregation systems storing inaccurate representations of source data records (e.g., where a format of data in a source data record is not correctly identified and/or not correctly transformed to a format used by the data aggregation system). As a result, the data aggregation system may not be able to attest to the integrity and accuracy of the data presented by the data aggregation system, and may frequently present inaccurate or incomplete data.

To overcome these technical challenges, the techniques described herein operate to enable an aggregation system to capture a visual representation of a data record, in substantially the same manner that the data record would have been presented by the source computer system. For instance, the techniques described herein might render a data record in a manner directed by the source system, and then create a visual capture of that rendered data record. The techniques described herein can then store this visual representation along with other information, such as metadata associated with the data record (e.g. which is usable to identify the data record), and a time at which the data record was accessed, rendered, captured, or stored. Later, the aggregation system can locate the stored representation of this data record based on the metadata, and can present the stored visual representation of the data record along with the stored metadata and/or the stored time at which the data record was accessed, rendered, captured, or stored. Thus, the aggregation system can present a representation of the data record in substantially the same manner in which the data record would have been presented by the source computer system, itself, along with an indication of a recency of the presented information. In embodiments, the techniques herein might also store cryptographic information usable to verify the integrity of any of the stored visual representation, the stored metadata, and/or the stored time information, and might then use this cryptographic information to verify the integrity of the stored data prior to its presentation.

In some embodiments, methods, systems, and computer program products capture an accurate and verifiable representation of a data record. For example, these embodiments can include accessing a data record from a data source, including accessing both (i) displayable data for the data record, and (ii) presentation information defining at least one of a layout or a style to be applied to the displayable data when the data record is rendered. These embodiments can also include rendering the accessed data record, including rendering one or more portions of the displayable data according to at least one of the layout or the style defined by the presentation information. These embodiments can also include capturing one or more visual representations of the rendered data record, including capturing one or more visual records of the rendered one or more portions of the displayable data. These embodiments can also include identifying one or more metadata items for identifying the data record, creating a timestamp, and creating cryptographic information usable to verify integrity of one or more of (i) the captured one or more visual representations, (ii) the one or more metadata items, or (iii) the timestamp. These embodiments can also include storing a representation of the data record, including storing (i) the one or more metadata items, (ii) the captured one or more visual representations of the rendered data record, (iii) the cryptographic information, and (iv) the timestamp.

In other embodiments, methods, systems, and computer program products provide an accurate and verified representation of a data record. These embodiments can include receiving one or more search terms, and searching an index to identify and obtain a stored representation of a data record. The stored representation of the data record can include (i) one or more metadata items matching the one or more search terms, (ii) one or more captured visual representations of a rendering of the data record, the one or more captured visual representations including one or more visual records of one or more portions of displayable data of the data record that have been rendered according to at least one of a layout or a style defined by presentation information associated with the data record, (iii) cryptographic information usable to verify integrity of the representation of the data record, and (iv) a timestamp. These embodiments also include using the cryptographic information to verify integrity of the representation of the data record and, based at least on verifying integrity of the representation of the data record, providing the representation of the data record, including providing (i) the one or more metadata items, (ii) the one or more captured visual representations, and (iii) the timestamp.

In yet other embodiments, methods, systems, and computer program products combine the capture and providing of an accurate and verified representation of a data record. These embodiments include accessing a data record from a data source, including accessing both (i) displayable data for the data record, and (ii) presentation information defining at least one of a layout or a style to be applied to the displayable data when the data record is rendered. These embodiments also include rendering the accessed data record, including rendering one or more portions of the displayable data according to at least one of the layout or the style defined by the presentation information. These embodiments also include capturing one or more visual representations of the rendered data record, including capturing one or more visual records of the rendered one or more portions of the displayable data. These embodiments also include identifying one or more metadata items for identifying the data record, creating a timestamp, and creating cryptographic information usable to verify integrity of one or more of (i) the captured one or more visual representations, (ii) the one or more metadata items, or (iii) the timestamp. These embodiments also include storing a representation of the data record, including storing (i) the one or more metadata items, (ii) the captured one or more visual representations of the rendered data record, (iii) the cryptographic information, and (iv) the timestamp. These embodiments also include, subsequent to storing the representation of the data record, receiving a request for the representation of the data record and, based on the request, identifying a stored representation of a data record and obtaining the stored representation of the data record. These embodiments also include using the cryptographic information to verify integrity of the representation of the data record and, based at least on verifying integrity of the representation of the data record, providing the representation of the data record, including providing (i) the one or more metadata items, (ii) the captured one or more visual representations, and (iii) the timestamp.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates capturing and providing an accurate and verified representation of a data record;

FIG. 2A illustrates an example of expanding an amount of displayable data rendered;

FIG. 2B illustrates an example of advancing through displayable data;

FIG. 3 illustrates a flow chart of an example method for capturing an accurate and verifiable representation of a data record;

FIG. 4 illustrates a flow chart of an example method for providing an accurate and verified representation of a data record; and

FIG. 5 illustrates a flow chart of an example method for capturing and providing an accurate and verified representation of a data record.

### DETAILED DESCRIPTION

At least some embodiments described herein are directed to computer-implemented data aggregation techniques that create aggregate collection(s) of data records that are sourced from a plurality of different source computer systems, each of which exposes its own collection(s) of data records. Thus, the techniques described herein can create aggregate collection(s) of data records that include the actual data obtained from data records stored in the various collections exposed by these disparate source computer systems. Embodiments can then offer the ability to search these aggregate collection(s), and to return matching data record data directly from these aggregate collection(s). Thus, the embodiments herein enable a searcher to perform searches across these various collections of data records (i.e., by virtue of searching the aggregate collection(s)), and to obtain information from the data records themselves, without actually needing to interact directly with the source computer systems from which the data records originated.

Notably, the inventor has recognized that significant technical challenges arise when implementing such computer-implemented data aggregation techniques. In particular, the inventor has recognized that it can be technically challenging to create aggregate collection(s) that include, and can in turn provide, a complete and/or accurate representation of a source data record as it would have been provided by a source computer system, itself. For example, while different source computer systems might expose similar types of data records, these source computer systems might do so in different ways. For instance, different source computer systems might refer to similar types of information with different or inconsistent naming standards, or might use different or inconsistent data formatting techniques. Additionally, in the case of unstructured data, it may be difficult to actually determine what data types and formats are being presented by a source computer system.

Thus, it can frequently be difficult, and sometimes impossible, for a data aggregation system to parse and store data from different source computer systems in a unified and consistent way, even if the data record types are similar across the source computer systems. This frequently leads to data aggregation systems storing incomplete representations of source data records (e.g., where a source data record includes data of a type that cannot be determined, or that doesn't map to a data type used by the data aggregation system). Additionally, or alternatively, this frequently leads to data aggregation systems storing inaccurate representations of source data records (e.g., where a format of data in a source data record is not correctly identified and/or not correctly transformed to a format used by the data aggregation system). As a result, the data aggregation system may not be able to attest to the integrity and accuracy of the data presented by the data aggregation system, and may frequently present inaccurate or incomplete data.

For example, suppose that a data aggregation system aggregates data records from various source computer systems operated by different courts, in which the data records exposed by these court's computer systems represent various court records (e.g., cases, citations, offenses, and the like). Taking traffic citations as an example, different court systems might present the same type of information in different ways. For instance, one court may label the citation as such, while other courts might label the citation as a ticket, a violation, etc. If a data aggregation system that aggregates records over all of these courts attempts to place records into a defined set of categories, it could easily miscategorize a record in a manner that misrepresents the actual record type. Even the data within a data record of the same type might be referred to inconsistently across jurisdictions. For instance, a court in one jurisdiction might label a speeding violation as such, while courts in other jurisdictions might label it as moving violation, as excessive speed, as driving beyond the posted speed limit, etc. If a data aggregation system that aggregates records over all of these courts' records attempts to place citations and violations covered by citations into a defined set of categories, it could easily miscategorize a record in a manner that misrepresents the actual violation for which the citation was created. Furthermore, even if different types of data are labeled similarly, this data may be formatted differently. For instance, one court might list dates in a MM-DD-YY format, while other courts might list them in a DD-MM-YY format, a YY-MM-DD format, and the like. Depending on the dates involved, the particular meaning of the date could be ambiguous. For instance, using the foregoing formatting standards, the string “06-11-12” could represent Jun. 11, 2012, Nov. 6, 2012, or Nov. 12, 2006. If a data aggregation system that aggregates records over all of these courts attempts to normalize or otherwise convert dates, it could easily misrepresent the true date intended by the court. In any of these cases, if a data aggregation system is unable to determine a data type and/or format for a particular piece of information, it may simply choose not to include that information in the aggregate data, leading to an incomplete representation of a data record.

To overcome these technical challenges, the techniques described herein operate to enable an aggregation system to capture a visual representation of a data record, in substantially the same manner that the data record would have been presented by the source computer system. For instance, the techniques described herein might render a data record in a manner directed by the source system, and then create a visual capture of that rendered data record. The techniques described herein can then store this visual representation along with other information, such as metadata associated with the data record (e.g. which is usable to identify the data record), and a time at which the data record was accessed, rendered, captured, or stored. Later, the aggregation system can locate the stored representation of this data record based on the metadata, and can present the stored visual representation of the data record along with the stored metadata and/or the stored time at which the data record was accessed, rendered, captured, or stored. Thus, the aggregation system can present a representation of the data record in substantially the same manner in which the data record would have been presented by the source computer system, itself, along with an indication of a recency of the presented information. In embodiments, the techniques herein might also store cryptographic information usable to verify the integrity of any of the stored visual representation, the stored metadata, and/or the stored time information, and might then use this cryptographic information to verify the integrity of the stored data prior to its presentation.

Returning the court record example, for instance, rather than attempting to parse and correctly interpret the data being presented in a court record, a data aggregation system implemented according to the embodiments herein can instead capture a representation of the data record in the manner intended by the court. Thus, a client system later receiving this data record from the data aggregation system can be sure that the data obtained is complete and correct, as per the intent of the court.

To the accomplishment of the foregoing, FIG. 1 illustrates an example computing environment 100 for capturing and providing an accurate and verified representation of a data record. As shown, computing environment 100 includes a computer system 101 that communicates with one or more source computer systems 117 and one or more client computer systems 118 (e.g., over one or more networks). In general, computer system 101 obtains data records from the source computer system(s) 117, stores representations of those data records in storage 110, and then provides those representations from the storage 110 to the client computer system(s) 118 (e.g., in response to queries from the client computer system(s) 118).

As shown, computer system 101 can include a data record scraping component 102 (scraping component 102), the storage 110, and a data record providing component 111 (providing component 111). As will be appreciated, computer system 101 might comprise a single physical computer system that includes and/or implements each of the scraping component 102, the storage 110, and the providing component 111. Alternatively, computer system 101 might comprise a plurality of physical computer systems over which the scraping component 102, the storage 110, and the providing component 111 are distributed in any manner.

In general, the scraping component 102 represents functionality implemented by computer system 101 to obtain data records from the source system(s) 117, and to create and store representations 110a of those data records in the storage 110. To demonstrate how the scraping component 102 might accomplish the foregoing, FIG. 1 illustrates a plurality of components (e.g., data record access 103, rendering 104, capture 105, metadata 106, timestamp 107, cryptography 108, representation storage 109, etc.) that represent various functions that the scraping component 102 might implement in accordance with various embodiments described herein. It will be appreciated, however, that the depicted components—including their identity, sub-components, and arrangement—are presented merely as an aid in describing various embodiments of the scraping component 102 described herein, and that these components are non-limiting to how software and/or hardware might implement the scraping component 102, or of the particular functionality thereof.

The data record access component 103 (access component 103) accesses the source system(s) 117 in order to obtain source data records. In embodiments, the access component 103 might operate as a data crawler/scraper, which operates to obtain all available data records (or a defined subset thereof) from a given source system 117. For example, the access component 103 might traverse a website presented by the source system 117 starting at a given starting Uniform Resource Locator (URL), and traversing all available URLs (or a defined subset thereof, such as by domain, search depth, etc.) that can be navigated to beginning at the starting URL. For instance, if the source system 117 is operated by a court, the access component 103 might access a URL of a court website that provides an index of court records, and use this index to access individual court records (e.g., by accessing a URL corresponding to each court record that is obtained from the index). The access component 103 might also operate to obtain particular data records, such as based on a request by the verification component 115, as discussed later.

The rendering component 104 generates a visual rendering of each accessed data record (e.g., each accessed court record) in a manner prescribed by the source system 117. For example, upon accessing a given URL from a source system 117, the access component 103 may obtain one or more data files, or a stream of data, from the source system 117. This data could include, for example, plain text data, image data, HyperText Markup Language (HTML) data, Cascading Style Sheet (CSS) data, JavaScript code, JavaScript Object Notation (JSON) data objects, (eXtensible Markup Language) XML data, and the like. As will be appreciated by one of ordinary skill in the art, such data might include displayable data for the data record (e.g., in the form of plain text, image, JSON, XML, etc.), along with presentation data (e.g., HTML, CSS, JavaScript, etc.) defining a layout and/or style to be applied to that displayable data. Upon receipt of this data, the rendering component 104 can generate a visual rendering of displayable data in accordance with the presentation data. For example, the rendering component 104 might utilize a browser engine (e.g., WebKit, Blink, Gecko, etc.) in order to generate the visual rendering of displayable data. As will be appreciated by one of ordinary skill in the art, this might include, for example, parsing the presentation data to generate a Document Object Model (DOM) representing HTML obtained from the source system 117, and then rendering the webpage from the DOM.

The rendering component 104 is shown as including an expansion component 104a. In embodiments, the expansion component 104a operates with a rendering, or a representation thereof (e.g., a DOM), in order to expand an amount of the displayable data that is presented in a rendering, or a plurality of renderings. This can include, for example, interacting with one or more rendered user interface controls (or pre-rendered representations thereof, such as in a DOM) in order to visually expand the amount of displayable data rendered, or advance through the available data.

To demonstrate operation of the expansion component 104a, FIG. 2A illustrates an example 200a of expanding an amount of displayable data rendered, while FIG. 2B illustrates an example 200b of advancing through displayable data. In FIG. 2A, illustrated is an initial rendering 201a of a data record, such as a court record corresponding to a traffic citation. In the example, the initial rendering 201a presents displayable data comprising general information from the citation's data record, such as a citation number, a defendant's name, and the defendant's date of birth. The initial rendering 201a also presents different categories of additional displayable data that are available from the citation's data record, such as counts, resolution, and fees. However, in the initial rendering 201a, these categories are initially rendered in a collapsed manner, which shows only the category type together with an expansion user interface control (i.e., a right-facing triangle) for expanding the category. An arrow 202 represents a transition between this initial rendering 201a, and a new rendering 201b that results from the expansion component 104a having interacted with the expansion user interface controls in the initial rendering 201a. As such, the new rendering 201b now shows this additional displayable data, such as the particular counts (i.e., speeding and driving without a license), a resolution (i.e., payment of fines), and fees (i.e., $500). As such, the expansion component 104a has expanded an amount of displayable data rendered by the rendering component 104. As will be appreciated by one of ordinary skill in the art, the expansion component 104a might interact with a great variety of expansion user interface control types, and this disclosure is not limited to the triangles illustrated in example 200a.

Turning now to FIG. 2B, illustrated is an initial rendering 203a of a data record, such as the court record discussed in connection with FIG. 2A. In the example, initial rendering 203a also presents displayable data comprising general information from the citation's data record, such as the citation number, the defendant's name, and the defendant's date of birth. In addition, the initial rendering 203a also presents different categories of additional displayable data that are available from the citation's data record, such as counts, resolution, and fees. However, in this case the initial rendering 203a presents these categories in a tabbed manner. As such, rather than expanding the amount of displayable data presented, the tabs enable the displayable data to be incrementally advanced through. An arrow 204 represents a transition between this initial rendering 203a, new renderings 203b-203d that result from the expansion component 104a having interacted with these tabs (as well as with expansion user interface controls). As such, rather than creating a single rendering (e.g., like new rendering 201b) that has been expanded to show the additional displayable data, example 200b shows three different renderings 203b-203d that together show this additional displayable data. As such, the expansion component 104a has interacted with tabs to advance through displayable data, resulting in multiple renderings by the rendering component 104. It is noted that the expansion component 104a can combine both interactions that expand content (e.g., expansion controls) and interactions that advance through content (e.g., tabs). For instance, in new rendering 203b, the expansion component 104a has also expanded categories of speeding and driving without a license to reveal details within those categories. As will be appreciated by one of ordinary skill in the art, the expansion component 104a might interact with a great variety of user interface controls to advance through content, and this disclosure is not limited to the tabs illustrated in example 200b.

After the rendering component 104 generates the visual rendering(s) of displayable data of a data record, the capture component 105 captures one or more visual representations of those rendering(s). The capture component 105 can do so in any appropriate manner, such as by generating a PostScript (PS) or Portable Document Format (PDF) capture of the rendering(s) (e.g., by utilizing a PS/PDF printer driver), or by generating an image-based capture of the of the rendering(s) (e.g., by utilizing screen capture software). In embodiments, the capture component 105 captures visual representation(s) that include the displayable data in a textual form. For example, a PS/PDF printer driver might capture the displayable data from a rendered webpage and/or from an underlying DOM. In another example, the capture component 105 might perform an Optical Character Recognition (OCR) on the visual representation. For instance, the capture component 105 might perform an OCR on screen capture data, or might perform an OCR on image data included in a PS or PDF file.

Since, as discussed in connection with the rendering component 104, generating a visual rendering of displayable data of a data record might include generating multiple renderings (e.g., to capture data associated with each tab in a data record), the capture component 105 might perform a capture of each of these multiple renderings. This could be accomplished by capturing these renderings individually, or capturing them in a single capture (e.g., by presenting the individual renderings next to each other).

The metadata component 106 gathers one or more metadata items for each accessed data record. While the metadata component 106 could gather any amount of metadata, including up to the entirety of the textual data associated with a data record, in embodiments, the metadata component 106 gathers at least one or more metadata items useable to identify the data record. For instance, the metadata component 106 might gather a source identifier for the data record (e.g., a source URL) and/or content obtained from the data record, itself. Returning to the example of data records comprising court records, for instance, metadata items might include one or more of a filing date, a case type, a defendant name, a plaintiff name, a defendant address, a plaintiff address, a case number, a citation number, a state, a zip code, a jurisdiction, a court, a unique identifier, and the like. Of course, the type of metadata gathered could vary widely depending on the information domain of the data records.

The timestamp component 107 gathers one or more timestamps that are usable to attest to when a captured representation of a data record was valid “as of.” As used herein, the term “timestamp” can comprise any information that is usable to define or derive a particular date and/or time. This could include, for example, one or more of: a count (e.g., a number of seconds from a given epoch); a representation of a year, a month, a week, and/or a day; a representation of an hour, a minute, a second, and/or a sub-second; a representation of a time zone; an indication of daylight savings time or standard time; and the like. In embodiments, the timestamp component 107 gathers a timestamp corresponding to an action by the scraping component 102, such as when the data record was accessed by the access component 103, when the data record was rendered by the rendering component 104, when the rendered data record was captured by the capture component 105, or when a representation 110a of the data record was stored into the storage 110 by the representation storage component 109.

The cryptography component 108 generates one or more cryptographic identifiers that are usable to verify integrity of data gathered or generated by one or more of the capture component 105, the metadata component 106, or the timestamp component 107. In embodiments, the cryptography component 108 uses such data as input to a cryptographic function, such as a checksum function, a hashing function (e.g., a MD5 message-digest algorithm (MD5); a Secure Hash Algorithm (SHA) such as SHA-1, SHA-256, SHA-512, etc.; and the like), an encryption function, and the like, to generate cryptographic information usable to verify integrity of the input data. For instance, the cryptography component 108 might use input data representing one or more visual representations generated by the capture component 105 as input to a hashing function to obtain a hash that is mathematically guaranteed to uniquely represent that data. Later, this same hashing function can be applied (e.g., by the verification component 115) to visual representation data to determine if that data is the same as the input data used to generate the hash. In embodiments, the cryptography component 108 could generate different cryptographic information for each data type (e.g., a different hash for data gathered or generated by each of the capture component 105, the metadata component 106, and/or the timestamp component 107). In other embodiments, the cryptography component 108 could generate cryptographic information over a combination of data types (e.g., a single hash for a concatenation of data gathered or generated by two or more of the capture component 105, the metadata component 106, and/or the timestamp component 107).

The representation storage component 109 (storage component 109) stores representations a data records in the storage 110 (i.e., representations 110a). In embodiments, for each representation, the storage component 109 stores at least (i) one or more visual representations of the data record that were captured by the capture component 105, (ii) one or more metadata items gathered by the metadata component 106, (iii) one or more timestamps generated by the timestamp component 107, and (iv) any cryptographic information generated by the cryptography component 108. As such, each stored representation 110a can be used by computer system 101 in order to provide an accurate and verifiable representation of the data record as it was originally presented by the source system 117 from which it was obtained.

The storage component 109 is shown as potentially including an indexing component 109a. The indexing component 109a generates or updates an index 110b that indexes the stored representations 110a based at least on the metadata item(s) gathered by the metadata component 106. As such, the stored representations 110a can be quickly located using the index 110b, using the metadata item(s) as search terms or key words.

In view of the foregoing description of the data record scraping component 102, FIG. 3 illustrates a flow chart of an example method 300 for capturing an accurate and verifiable representation of a data record. Method 300 will be described with respect to the components and data of computing environment 100. Although acts of method 300 may be discussed in a certain order, or may be illustrated as occurring in a particular order, no particular ordering is required unless specifically stated, or required because an act is dependent on another act being completed prior to the act being performed.

As shown, method 300 includes an act 301 of accessing a data record from a data source. In some embodiments, act 301 comprises accessing a data record from a data source, including accessing both (i) displayable data for the data record, and (ii) presentation information defining at least one of a layout or a style to be applied to the displayable data when the data record is rendered. For example, the access component 103 can access a data record from a source system 117. For instance, this might be part of a data crawling of the source system 117, or as a request for a particular data record from the source system 117 (e.g., based on a request by the verification component 115, as discussed later).

Method 300 also includes an act 302 of identifying data record metadata, an act 303 of creating a timestamp, and an act 304 of rendering the data record according to presentation information. As shown, method 300 imposes no particular ordering among acts 302-304. As such, depending on implementation, acts 302-304 might be performed serially (in any order), and/or in parallel.

Turning to act 302, in some embodiments, act 302 comprises identifying one or more metadata items for identifying the data record. For example, the metadata component 106 can gather one or more metadata items for the accessed data record. In embodiments, these metadata item(s) include metadata items that could be used for searching for the data record later. For instance, if the source system 117 provides a court website, and the data record is a court record, the metadata items could include such things as filing date, a case type, a defendant name, a plaintiff name, a defendant address, a plaintiff address, a case number, a citation number, a state, a zip code, a jurisdiction, a court, a unique identifier, etc.

Turning to act 303, in some embodiments, act 303 comprises creating a timestamp. For example, the timestamp component 107 could gather one or more timestamps that are usable to attest to when a captured representation of a data record was valid “as of.” This timestamp could be in any format that can be used to specify or derive a validity date and/or time, and could correspond to a time of performance of act by method 400. Thus, for example, the timestamp might represent at least one of (i) a date/time of the accessing the data record from the data source, (ii) a date/time of the rendering the accessed data record, (iii) a date/time of the capturing the one or more visual representations of the rendered data record, or (iv) a date/time of the storing the representation of the data record. While, for ease in description, act 303 is shown as occurring prior to act 306 (i.e., for creating cryptographic information), it could alternatively occur after, or in parallel with, act 306—such that the timestamp could capture a time of the generation of the cryptographic information, or a time of storing of a representation of the data record.

Turning to act 304, in some embodiments, act 304 comprises rendering the accessed data record, including rendering one or more portions of the displayable data according to at least one of the layout or the style defined by the presentation information. For example, the rendering component 104 can generate visual rendering(s) of each accessed data record (e.g., each accessed court record) in a manner prescribed by the source system 117. For instance, if the presentation information comprises HTML/CSS, the rendering component 104 might utilize a browser engine to generate the visual rendering of displayable data. As discussed, the rendering component 104 might utilize the expansion component 104a to expand an amount of displayable data rendered (e.g., by using an expansion user interface control) and/or to advancing an amount of displayable data rendered (e.g., by using tabs, links, or other mechanisms). Thus in act 304, rendering the accessed data record might comprise one or more of automatically interacting with a user interface control to increase an amount of the displayable data that is rendered (e.g., by using an expansion user interface control), or rendering a first portion of the displayable data in a first rendering and rendering a second portion of the displayable data in a second rendering (e.g., by rendering content for different tabs).

Following act 304, method 300 also includes an act 305 of capturing the rendered data record. In some embodiments, act 305 comprises capturing one or more visual representations of the rendered data record, including capturing one or more visual records of the rendered one or more portions of the displayable data. For example, the capture component 105 can capture one or more visual representations of the rendering(s) produced by the rendering component 104. As discussed, this capture could be in any format that can be used to accurately provide a representation of the rendering, such as a PS/PDF document, a screen capture, etc. In embodiments, the act 305 could potentially capture non-static information, such as animations, videos, audio, etc. For instance, the capture component 105 could embed multimedia files in a PDF file.

In embodiments, capturing the one or more visual representations of the rendered data record could comprise capturing one or more text-searchable visual representations. For instance, text data could be obtained from a rendered webpage, from an underlying DOM, etc. At times, capturing one or more text-searchable visual representations could include performing an OCR on image data. For instance, the capture component 105 might perform an OCR one or more images embedded a produced PS/PDF file, or might perform an OCR image data representing a screen capture, etc. For instance, returning to the court record example, a court record might include textual data displayed in a webpage, as well as an image (e.g., a scan) of a supporting physical document such as a ticket. In this case, the capture component 105 might generate a PS/PDF file that includes the textual data as obtained from the rendered webpage (or its underlying DOM), the image of the ticket, and searchable text for the ticket that is generated by OCR.

At times, the rendering component 104 might generate multiple renderings for a data record in act 304. In these circumstances, the capture component 105 can include each of these renderings in the produced file(s). For example, multiple renderings might be displayed side-by-side in a single capture. Alternatively, multiple rendering might be captured as different pages of a PS/PDF file, etc. In this latter circumstance, capturing the one or more visual representations of the rendered data record might comprise capturing a first visual record of the rendered first portion of the displayable data (e.g., a first PDF page capturing a first rendering), and capturing a second visual record of the rendered second portion of the displayable data (e.g., a second PDF page capturing a second rendering).

Method 300 also includes an act 306 of creating cryptographic information. In some embodiments, act 306 comprises creating cryptographic information usable to verify integrity of one or more of (i) the captured one or more visual representations, (ii) the one or more metadata items, or (iii) the timestamp. For example, the cryptography component 108 can generate one or more cryptographic identifiers, such as one or more hashes, that are usable to verify integrity of data gathered or generated by one or more of the capture component 105, the metadata component 106, or the timestamp component 107. For instance, the cryptography component 108 can utilize one or more of these data items as input to a cryptographic hashing algorithm (e.g., MD5, SHA, etc.) to obtain an identifier that uniquely represents that input data. Thus, in act 306, creating the cryptographic information from the captured one or more visual representations could comprise creating one or more hashes of data comprising one or more of (i) the one or more metadata items, (ii) the captured one or more visual representations, or (iii) the timestamp.

Method 300 also includes an act 307 of storing a representation of the data record. In some embodiments, act 307 comprises storing a representation of the data record, including storing (i) the one or more metadata items, (ii) the captured one or more visual representations of the rendered data record, (iii) the cryptographic information, and (iv) the timestamp. For example, the storage component 109 can store a representations of the accessed data record as a representations 110a in storage 110. This representation can include, for example, one or more visual representations generated in act 305, one or more metadata items gathered in act 302, one or more timestamps generated in act 303, and/or any cryptographic information generated in act 306. In embodiments, act 307 could include the indexing component 109a adding the stored representation to an index. For instance, the stored representation could be indexed according to one or more of its metadata items. As such, act 307 might include storing one or more references to the stored representation of the data record in a searchable index, the one or more references being identifiable in the index based on the one or more metadata items.

Returning to FIG. 1, the providing component 111 represents functionality implemented by computer system 101 to locate and obtain representations 110a of data records from the storage 110, and to present or otherwise provide those representations 110a to the client system(s) 118. To demonstrate how the providing component 111 might accomplish the foregoing, FIG. 1 illustrates a plurality of components (e.g., input 112, search 113, representation access 114, verification 115, presentation 116, etc.) that represent various functions that the providing component 111 might implement in accordance with various embodiments described herein. It will be appreciated, however, that the depicted components—including their identity, sub-components, and arrangement—are presented merely as an aid in describing various embodiments of the providing component 111 described herein, and that these components are non-limiting to how software and/or hardware might implement the providing component 111, or of the particular functionality thereof.

The input component 112 receives queries from the client system(s) 118 for searching for representations 110a of data records stored by computer system 101 (e.g., in storage 110), and which include an aggregation of data records across the source system(s) 117. For example, these queries can include search terms or other key words for use by the providing component 111 to locate particular data record(s) in the representations 110a, and to provide those data record(s) to the requesting client system 118.

Upon receipt of a query, the providing component 111 uses the search component 113 to locate any matching representation(s) 110a in storage 110. In embodiments, the search component 113 might search the stored metadata from the representations 110a, directly. In other embodiments, however, the search component 113 might search the index 110b which, as discussed in connection with the indexing component 109a, can index the representations 110a based on their metadata.

After locating matching representation(s) in the storage 110 from among the stored representation(s) 110a, the representation access component 114 (access component 114) can access or otherwise obtain the matching representation(s) from the storage 110 including, for example, obtaining one or more metadata items, obtaining one or more visual representations of a rendered data record, obtaining one or more timestamps, and obtaining cryptographic information.

After obtaining the matching representation(s), the verification component 115 can validate one or more of (i) a recency of the obtained representation(s) or (ii) an integrity of the obtained representation(s). As for recency, the verification component 115 might use an obtained timestamp to determine how recently an obtained representation was obtained from a source system 117. If the recency is beyond a recency threshold (i.e., the representation is too old), the verification component 115 might send one or more messages to the scraping component 102 that initiate a new capture of the data record. For instance, these message(s) might cause the data record access component 103 to access that data record specifically, and to initiate a rendering, capture, etc. of that data record to create a new representation of the data record in the storage 110. Then, the verification component 115 might cause the access component 114 to fetch this new representation of the data record. In embodiments, the recency threshold might be defined globally by the providing component 111, or could be provided by a client system 118 as part of a query.

As for integrity, as discussed in connection with the cryptography component 108 and the storage component 109, each representation 110a can include cryptographic information, such as checksum(s) or hash(es), that can be used to verify integrity of the other data stored in the representation 110a. For example, as discussed, the cryptography component 108 may have generated different cryptographic information for each data type associated with the representation (e.g., a different hash for data gathered or generated by each of the capture component 105, the metadata component 106, and/or the timestamp component 107), or might have generated cryptographic information over a combination of data types (e.g., a single hash for a concatenation of data gathered or generated by two or more of the capture component 105, the metadata component 106, and/or the timestamp component 107). Regardless of the form of the cryptographic information, the verification component 115 can use like data accessed from the storage 110 as input to the same cryptographic function(s) to generate new cryptographic information (e.g., one or more new hashes). The verification component 115 can then compare this newly-generated cryptographic information to the cryptographic information obtained from the representation 110a. If the cryptographic information is the same, then the verification component 115 can validate integrity of the obtained representation.

Once recency and/or integrity of the obtained representation(s) 110a has been validated by the verification component 115 (and a new representation has been scraped from a source system 117, if needed), the presentation component 116 can present the obtained representation(s) 110a to the requesting client system 118. The manner of the presentation may vary widely, depending on implementation, needs of the client system(s) 118, etc. For example, the presentation component 116 might send one or more messages to a requesting client system 118 that communicate one or more of the obtained metadata item(s), visual representation(s), timestamp(s), and/or cryptographic information to the client system 118 for consumption by the client system 118 in any manner determined by the client system 118. In another example, the presentation component 116 might generate a visual rendering that includes one or more of these items, and send that visual rendering to the client system 118. In another example, the presentation component 116 might send one or more of these items to the client system 118 along with presentation information, such as HTML, CSS, and the like, such that the client system 118 is enabled to render these items according to the presentation information.

In view of the foregoing description of the data record providing component 111, FIG. 4 illustrates a flow chart of an example method 400 for providing an accurate and verified representation of a data record. Method 400 will be described with respect to the components and data of computing environment 100. Although acts of method 400 may be discussed in a certain order, or may be illustrated as occurring in a particular order, no particular ordering is required unless specifically stated, or required because an act is dependent on another act being completed prior to the act being performed.

As shown, method 400 includes an act 401 of receiving a search term. In some embodiments, act 401 comprises receiving one or more search terms. For example, the input component 112 can receive one or more queries from a client system 118, for searching for data records stored by computer system 101.

Method 400 also includes an act 402 of using the search term to identify a representation of a data record. In some embodiments, act 402 comprises searching an index to identify a stored representation of a data record. For example, using the search component 113, the providing component 111 can locate any matching representation(s) 110a in storage 110. While the search component 113 might search index 110b, the search component 113 could additionally, or alternatively, search metadata of the representations 110a directly.

Method 400 also includes an act 403 of obtaining the representation of the data record. In some embodiments, act 403 comprises obtaining the stored representation of the data record, including obtaining, (i) one or more metadata items matching the one or more search terms, (ii) one or more captured visual representations of a rendering of the data record, the one or more captured visual representations including one or more visual records of one or more portions of displayable data of the data record that have been rendered according to at least one of a layout or a style defined by presentation information associated with the data record, (iii) cryptographic information usable to verify the integrity of the representation of the data record, and (iv) a timestamp. For example, the access component 114 can access the foregoing data items (i.e., metadata, captured visual representation(s), cryptographic information, and timestamp) from a stored representation 110a. In embodiments, these data items correspond generally to corresponding items as discussed in connection with the record scraping component 102 and method 300.

Method 400 also includes an act 404 of using cryptographic information to verify integrity of the representation of the data record. In some embodiments, act 404 comprises using the cryptographic information to verify integrity of the representation of the data record. For example, the verification component 115 can utilize the one or more of the data items accessed in act 403 as input to a cryptographic algorithm that was used to generate the cryptographic information what was accessed in act 403. Then, the verification component 115 compare newly-generated cryptographic information with the accessed cryptographic information to determine whether or not they are the same. If they are the same, integrity of the representation of the data record can be verified. In embodiments, verifying integrity of the representation of the data record can comprise using the cryptographic information to verify integrity of one or more of (i) the one or more metadata items, (ii) the one or more captured visual representations, or (iii) the timestamp. This may include comparing one or more cryptographic hashes to data comprising one or more of (i) the one or more metadata items, (ii) the one or more captured visual representations, or (iii) the timestamp.

Method 400 also includes an act 405 of providing a representation of the data record, including data record metadata, a captured visual representation of the data record, and recency information. In some embodiments, act 405 comprises, based at least on verifying integrity of the representation of the data record, providing the representation of the data record, including providing (i) the one or more metadata items, (ii) the one or more captured visual representations, and (iii) the timestamp. For example, the presentation component 116 can present the obtained representation(s) 110a to the requesting client system 118 in any appropriate manner, such as by providing one or more of the accessed data items to the requesting client system 118 directly, generating and sending to the requesting client system 118 a visual rendering of the representation of the data record, sending to the requesting client system 118 the one or more of the accessed data items along with presentation information, etc. Thus, act 405 could include, for example, sending the one or more metadata items, the one or more captured visual representations, and the timestamp to another computer system; sending a rendering of the one or more metadata items, the one or more captured visual representations, and the timestamp to another computer system; sending the one or more metadata items, the one or more captured visual representations, and the timestamp to another computer system along with presentation information; etc.

As mentioned, the verification component 115 could additionally verify recency of the obtained representation. If that recency exceeds a threshold (which could be globally defined, or defined by a client system 118, for example), the verification component 115 can cause a new version of the representation to be obtained/generated by the scraping component 102. Thus, method 400 could also include, prior to providing the representation of the data record, using the timestamp to determine a recency of the representation of the data record. Then, based on the recency exceeding a threshold, method 400 could also include requesting that a new representation of the data record be created based on accessing the data record from a data source, and receiving the new representation of the data record. The new representation can be associated with a more recent timestamp than the timestamp. Then, in act 405, providing the representation of the data record could comprise providing the new representation of the data record.

As will be appreciated in view of the disclosure herein, methods 300 and 400 could be considered separate methods (e.g., performed by separate computer systems, or performed at different times at the same computer system), or could be combined into a single method (e.g., performed by a single computer system). For example, FIG. 5 illustrates a flow chart of an example method 500 for capturing and providing an accurate and verified representation of a data record. Although acts of method 500 may be discussed in a certain order, or may be illustrated as occurring in a particular order, no particular ordering is required unless specifically stated, or required because an act is dependent on another act being completed prior to the act being performed.

Method 500 includes an act 501 of accessing a data record from a data source. In some embodiments, act 501 comprises accessing a data record from a data source, including accessing both (i) displayable data for the data record, and (ii) presentation information defining at least one of a layout or a style to be applied to the displayable data when the data record is rendered. For example, act 501 might correspond generally to act 301 of method 300.

Method 500 also includes an act 502 of identifying data record metadata, an act 503 of creating a timestamp, and an act 504 of rendering the data record according to presentation information. As shown, method 500 imposes no particular ordering among acts 502-504. As such, depending on implementation, acts 502-504 might be performed serially (in any order), and/or in parallel.

Turning to act 502, in some embodiments, act 502 comprises identifying one or more metadata items for identifying the data record. For example, act 502 might correspond generally to act 302 of method 300.

Turning to act 503, in some embodiments, act 503 comprises creating a timestamp. For example, act 503 might correspond generally to act 303 of method 300.

Turning to act 504, in some embodiments, act 504 comprises rendering the accessed data record, including rendering one or more portions of the displayable data according to at least one of the layout or the style defined by the presentation information. For example, act 504 might correspond generally to act 304 of method 300.

Method 500 also includes an act 505 of capturing the rendered data record. In some embodiments, act 505 comprises capturing one or more visual representations of the rendered data record, including capturing one or more visual records of the rendered one or more portions of the displayable data. For example, act 505 might correspond generally to act 305 of method 300.

Method 500 includes an act 506 of creating cryptographic information. In some embodiments, act 506 comprises creating cryptographic information usable to verify integrity of one or more of (i) the captured one or more visual representations, (ii) the one or more metadata items, or (iii) the timestamp. For example, act 506 might correspond generally to act 306 of method 300.

Method 500 includes an act 507 of storing a representation of the data record. In some embodiments, act 507 comprises storing a representation of the data record, including storing (i) the one or more metadata items, (ii) the captured one or more visual representations of the rendered data record, (iii) the cryptographic information, and (iv) the timestamp. For example, act 507 might correspond generally to act 307 of method 300.

Method 500 includes an act 508 of receiving a search term. In some embodiments, act 508 comprises, subsequent to storing the representation of the data record, receiving a request for the representation of the data record. For example, act 508 might correspond generally to act 401 of method 400.

Method 500 includes an act 509 of using the search term to identify and obtain the representation of the data record. In some embodiments, act 509 comprises, based on the request, identifying a stored representation of a data record and obtaining the stored representation of the data record. For example, act 509 might correspond generally to acts 402 and 403 of method 400.

Method 500 includes an act 510 of using the cryptographic information to verify integrity of the representation of the data record. In some embodiments, act 511 comprises using the cryptographic information to verify integrity of the representation of the data record. For example, act 510 might correspond generally to act 404 of method 400.

Method 500 includes an act 511 of providing a representation of the data record, including the data record metadata, the captured visual representation of the data record, and the timestamp. In some embodiments, act 511 comprises, based at least on verifying integrity of the representation of the data record, providing the representation of the data record, including providing (i) the one or more metadata items, (ii) the captured one or more visual representations, and (iii) the timestamp. For example, act 511 might correspond generally to act 405 of method 400.

Accordingly, the embodiments described herein enable aggregation systems to capture visual representations of data records, in substantially the same manner that those data records would have been presented by a source computer system. This enables aggregation systems to present representations of those data records in substantially the same manner in which the data records would have been presented by their source computer system. In this way, the embodiments described herein can improve the completeness and accuracy of presented data as compared to existing data record aggregation techniques. Additionally, by utilizing cryptography and timestamps, the embodiments described herein can attest to the accuracy and the recency of the data that is being presented, unlike existing data record aggregation techniques.

It is noted that the technical embodiments described herein could be used to improve the comprehensiveness and accuracy of data aggregation for a variety of industries and data types. As a non-limiting example, one industry for which the comprehensive and accurate data aggregation enabled by the embodiments herein might be of particular benefit is the background check industry. For example, entities responsible for conducting background checks frequently rely on data from a broad variety of data sources, such as court records from jurisdictions that span different cities, different counties, different states, and potentially even different countries. By capturing visual representations of data records in their entirety along with metadata, and by enabling those visual representations to be validated cryptographically, the embodiments herein can enable these disparate court records to be efficiently aggregated and searched while preserving the accuracy and integrity of these court records. Further, as will be appreciated, it can be important for entities that conduct background checks to verify that they are relying on up-to-date data. By also capturing “as of” timestamps, and by enabling those timestamps to be validated cryptographically, the embodiments herein can also enable the recency of these court records to be quickly validated.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements.

What is claimed:

1. A method, implemented at a computer system that includes at least one processor, for capturing an accurate and verifiable representation of a data record, the method comprising:
accessing a data record from a data source, including accessing both (i) displayable data for the data record, and (ii) presentation information defining at least one of a layout or a style to be applied to the displayable data when the data record is rendered;
rendering the accessed data record, including rendering one or more portions of the displayable data according to at least one of the layout or the style defined by the presentation information;
capturing one or more visual representations of the rendered data record, including capturing one or more visual records of the rendered one or more portions of the displayable data;
identifying one or more metadata items for identifying the data record;
creating a timestamp;
creating cryptographic information usable to verify integrity of one or more of (i) the captured one or more visual representations, (ii) the one or more metadata items, or (iii) the timestamp; and
storing a representation of the data record, including storing (i) the one or more metadata items, (ii) the captured one or more visual representations of the rendered data record, (iii) the cryptographic information, and (iv) the timestamp.

2. The method of claim 1, wherein rendering the accessed data record comprises automatically interacting with a user interface control to increase an amount of the displayable data that is rendered.

3. The method of claim 1, wherein,
rendering the accessed data record comprises rendering a first portion of the displayable data in a first rendering, and rendering a second portion of the displayable data in a second rendering, and
capturing the one or more visual representations of the rendered data record comprises capturing a first visual record of the rendered first portion of the displayable data, and capturing a second visual record of the rendered second portion of the displayable data.

4. The method of claim 1, wherein creating the cryptographic information from the captured one or more visual representations comprises creating one or more hashes of data comprising one or more of (i) the one or more metadata items, (ii) the captured one or more visual representations, or (iii) the timestamp.

5. The method of claim 1, wherein the timestamp represents at least one of (i) a date and time of the accessing the data record from the data source, (ii) a date and time of the rendering the accessed data record, (iii) a date and time of the capturing the one or more visual representations of the rendered data record, or (iv) a date and time of the storing the representation of the data record.

6. The method of claim 1, further comprising storing one or more references to the stored representation of the data record in a searchable index, the one or more references being identifiable in the index based on the one or more metadata items.

7. The method of claim 1, wherein capturing the one or more visual representations of the rendered data record comprises capturing one or more text-searchable visual representations.

8. The method of claim 7, wherein capturing the one or more text-searchable visual representations comprises performing an optical character recognition on image data.

9. A method, implemented at a computer system that includes at least one processor, for providing an accurate and verified representation of a data record, the method comprising:
receiving one or more search terms;
searching an index to identify a stored representation of a data record;
obtaining the stored representation of the data record, including obtaining,
(i) one or more metadata items matching the one or more search terms,
(ii) one or more captured visual representations of a rendering of the data record, the one or more captured visual representations including one or more visual records of one or more portions of displayable data of the data record that have been rendered according to at least one of a layout or a style defined by presentation information associated with the data record,
(iii) cryptographic information usable to verify integrity of the representation of the data record, and
(iv) a timestamp;
using the cryptographic information to verify integrity of the representation of the data record; and
based at least on verifying integrity of the representation of the data record, providing the representation of the data record, including providing (i) the one or more metadata items, (ii) the one or more captured visual representations, and (iii) the timestamp.

10. The method of claim 9, further comprising:
prior to providing the representation of the data record, using the timestamp to determine a recency of the representation of the data record;
based on the recency exceeding a threshold, requesting that a new representation of the data record be created based on accessing the data record from a data source; and
receiving the new representation of the data record, the new representation being associated with a more recent timestamp than the timestamp,
wherein providing the representation of the data record comprises providing the new representation of the data record.

11. The method of claim 9, wherein the timestamp is an indication of at least one of (i) a date and time of an access of data record from a data source, (ii) a date and time of a rendering of the data record, (iii) a date and time of capturing the one or more visual representations, or (iv) a date and time of a storing of the representation of the data record.

12. The method of claim 9, wherein verifying integrity of the representation of the data record comprises using the cryptographic information to verify integrity of one or more of (i) the one or more metadata items, (ii) the one or more captured visual representations, or (iii) the timestamp.

13. The method of claim 9, wherein verifying integrity of the representation of the data record comprises comparing one or more cryptographic hashes to data comprising one or more of (i) the one or more metadata items, (ii) the one or more captured visual representations, or (iii) the timestamp.

14. The method of claim 9, wherein the providing comprises sending a rendering of the one or more metadata items, the one or more captured visual representations, and the timestamp to another computer system.

15. The method of claim 9, wherein the providing comprises sending the one or more metadata items, the one or more captured visual representations, and the timestamp to another computer system.

16. A computer system comprising:
at least one processor; and
one or more computer readable media having stored thereon computer-executable instructions that are executable by at the least one processor to cause the computer system to capture and provide an accurate and verified representation of a data record, the computer-executable instructions including instructions that are executable by the at least one processor to cause the computer system to perform at least the following:
access a data record from a data source, including accessing both (i) displayable data for the data record, and (ii) presentation information defining at least one of a layout or a style to be applied to the displayable data when the data record is rendered;
render the accessed data record, including rendering one or more portions of the displayable data according to at least one of the layout or the style defined by the presentation information;
capture one or more visual representations of the rendered data record, including capturing one or more visual records of the rendered one or more portions of the displayable data;
identify one or more metadata items for identifying the data record;
create a timestamp;
create cryptographic information usable to verify integrity of one or more of (i) the captured one or more visual representations, (ii) the one or more metadata items, or (iii) the timestamp;
store a representation of the data record, including storing (i) the one or more metadata items, (ii) the captured one or more visual representations of the rendered data record, (iii) the cryptographic information, and (iv) the timestamp;
subsequent to storing the representation of the data record, receive a request for the representation of the data record;
based on the request, identify a stored representation of a data record and obtain the stored representation of the data record;
use the cryptographic information to verify integrity of the representation of the data record; and
based at least on verifying integrity of the representation of the data record, provide the representation of the data record, including providing (i) the one or more metadata items, (ii) the captured one or more visual representations, and (iii) the timestamp.

17. The computer system of claim 16, wherein storing the representation of the data record includes storing one or more references to the representation of the data record in a searchable index, the one or more references being identifiable in the index based on the one or more metadata items.

18. The computer system of claim 16, wherein receiving the request for the representation of the data record comprises receiving one or more search terms matching the one or more metadata items.

19. The computer system of claim 16, wherein verifying integrity of the representation of the data record comprises comparing one or more cryptographic hashes to data comprising one or more of (i) the one or more metadata items, (ii) the captured one or more visual representations, or (iii) the timestamp.

20. The computer system of claim 16, wherein the providing comprises sending the one or more metadata items, the captured one or more visual representations, and the timestamp to another computer system.
